(19) United States
(12) Patent Application Publication
(10) Pub. No.: US 2010/0128141 A1
(43) Pub. Date: May 27, 2010

(54) METHOD AND APPARATUS FOR DETERMINING SIMILARITY BETWEEN IMAGES

(75) Inventor: Soon-geun Jang, Suwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/622,577

(22) Filed: Nov. 20, 2009

(30) Foreign Application Priority Data
Nov. 21, 2008 (KR) 10-2008-0116372

(51) Int. Cl. H04N 5/228; G06K 9/00

(52) U.S. Cl. 348/222.1; 382/170; 348/E05.031

(57) ABSTRACT

A method and apparatus for determining a similarity between an input image and a template image may determine the similarity by using a difference in histogram degree between the input image and the template image, in a reduced period of time, which increases efficiency.

### CROSS-REFERENCE TO RELATED PATENT APPLICATION

This application claims the priority benefit of Korean Patent Application No. 10-2008-0116372, filed on Nov. 21, 2008, in the Korean Intellectual Property Office, the disclosure of which is incorporated herein in its entirety by reference.

### BACKGROUND

1. Field of the Invention

The present invention generally relates to a method and apparatus for determining a similarity between images, and more particularly, a method and apparatus for determining a similarity between an input image and a template image.

2. Description of the Related Art

Conventionally, a mean-shift method measures a similarity between a template image and an input image (e.g., see D. Comaniciu and P. Meer, “Mean shift: A robust approach toward feature space analysis”, IEEE Transactions PAMI, Vol. 24, No. 5, May 2002, pp. 603-619). The mean-shift method converts RGB image data representing an object seen at a distance into YCbCR or Lab image data and uses repeated estimation, which requires a great amount of calculation.

### SUMMARY

A method and apparatus for determining a similarity between an input image and a template image may determine the similarity by using a difference in histogram degree between the input image and the template image, in a reduced period of time, which increases efficiency.

In an embodiment, a method for determining similarity between images includes inputting an image, creating a difference in histogram degree between the image and a template image, and determining that the smaller the difference is, the greater the similarity.

The method may further include scanning the image, and creating a difference in histogram degree between an area of the scanned image and the template image.

The area of the scanned image may have a same size as the template image.

A plurality of difference in histogram degrees may be created, in which each of the plurality of difference in histogram degrees may be created using a different channel.

The method may further include creating a difference in a gradation degree of each channel, calculating a sum of the differences in all channels and all gradations, and determining that the smaller the sum is, the greater the similarity.

The difference in histogram degree may be created in terms of chroma and brightness.

The method may further include creating a difference in histogram degree between a first area of the image and the template image, and creating a difference in histogram degree between a second area of the image and the template image.

The creating of the difference in histogram degree between the second area of the scanned image and the template image may include creating a difference in a first histogram degree between an area where the first area and the second area overlap and the template image, creating a difference in a second histogram degree between an area of the first area that is added to the second area and the template image, and creating the difference in the histogram degree between the second area and the template image by adding the difference in the first histogram degree to the difference in the second histogram degree.

The creating of the difference in histogram degree between the second area of the scanned image and the template image may include creating a difference in a second histogram degree between an area of the second area that is added to the first area and the template image, creating a difference in a third histogram degree between an area of the first area that is excluded from the second area and the template image, adding the difference in the second histogram degree to the difference in histogram degree between the first area and the template image, and subtracting the difference in the third histogram degree.

The creating of the difference in the first histogram degree between the area where the first area and the second area overlap and the template image may include excluding a difference in the histogram degree between the template image and an area where the first area and the second area do not overlap from the difference in the histogram degree between the first area and the template image.

The method may further include inputting a plurality of previous images, predicting a location of an object of a current image from the plurality of previous images, inputting the current image, and creating a difference in histogram degree between the template image and an image of an object area including the location of the object of the current image.

The predicting of the location of the object of the current image from the plurality of previous images may include using an average and a variance of a speed of motion of the object.

The method may further include scanning the object area, and creating a difference in histogram degree between an area of the scanned object area and the template image.

The method may further include creating a difference in a gradation degree of each channel, calculating a sum of the differences in all channels and all gradations, and determining that the smaller the sum is, the greater the similarity.

The method may further include creating a difference in histogram degree between the template image and a plurality of areas of the object area, determining that the object area does not include the object if a smallest difference value is greater than a boundary value, inputting a next image, and creating a difference in histogram degree between the template image and a plurality of images of the next image.

The method may further include creating the difference in histogram degree between the template image and a plurality of areas of the object area, comparing a minimum range of differences in histogram degree between the previous images and the template image and a smallest difference value between the template image and the object area, inputting a next image, and creating a difference in histogram degree between the template image and a plurality of images of the next image.

In another embodiment, a similarity determining apparatus may include a histogram creating unit configured for creating a histogram of an input image, a first calculating unit configured for creating a difference in histogram degree between the input image and a template image, and a similarity determining unit configured for determining that the smaller the difference is, the greater the similarity.

The first calculating unit may be further configured for creating a plurality of difference in histogram degrees, each of the plurality of difference in histogram degrees being created using a different channel.

The first calculating unit may be further configured for calculating a sum of differences in histogram degree between the input image and the template image in all channels and all gradations.

The apparatus may further include a scanning unit configured for scanning the input image and specifying a plurality of areas of the input image. The histogram creating unit may be further configured for creating a histogram of each area of the input image specified by the scanning unit. The first calculating unit may be further configured for creating a difference in histogram degree between each area of the input image and the template image.

The scanning unit may be further configured for sequentially specifying first and second areas of the input image. The histogram creating unit may be further configured for creating a histogram of the first area of the input image. The first calculating unit may be further configured for creating a difference in histogram degree between the first area of the input image and the template image. The apparatus may further include a second calculating unit configured for creating a difference in histogram degree between the second area of the input image and the template image by adding a difference in a first histogram degree between an area where the first area and the second area overlap and the template image to a difference in a second histogram degree between an area of the first area that is added to the second area and the template image.

The second calculating unit may be further configured for subtracting a difference in histogram degree between the template image and an area where the first area and the second area do not overlap from the difference in histogram degree between the template image and the first area.

The second calculating unit may be further configured for creating a difference in histogram degree between the second area of the input image and the template image by creating a difference in a second histogram degree between an area of the second area that is added to the first area and the template image, creating a difference in a third histogram degree between an area of the first area that is excluded from the second area and the template image, adding the difference in the second histogram degree to the difference in histogram degree between the first area and the template image, and subtracting the difference in the third histogram degree.

The apparatus may further include an object area predicting unit configured for predicting an object area including a location of an object of a current image from a plurality of previous images.

The apparatus may further include a scanning unit configured for scanning the object area and specifying a plurality of areas of the object area. The histogram creating unit may be further configured for creating a histogram of at least one area of the object area specified by the scanning unit.

The histogram creating unit may be further configured for creating a histogram of the object area. The first calculating unit may be further configured for creating a difference in histogram degree between the object area and the template image.

The apparatus may further include a scanning controller configured for determining whether the difference in histogram degree between the object area of the current image and the template image is greater than a boundary value, and if the difference is greater than the boundary value, controlling to scan a next image.

The apparatus may further include a scanning controller configured for determining whether the difference in histogram degree between the object area of the current image and the template image is greater than a minimum range of previous images, and if the difference is greater than the minimum range, controlling to scan a next image.

### BRIEF DESCRIPTION OF THE DRAWINGS

FIG. 1 is a block diagram of an exemplary apparatus for determining a similarity between images.

FIG. 2 is a block diagram of an exemplary digital signal processor (DSP) of the apparatus for determining the similarity shown in FIG. 1.

FIG. 3A illustrates an exemplary template image.

FIG. 3B illustrates an exemplary input image.

FIGS. 4A and 4B are graphs illustrating exemplary histograms of channels of a template image.

FIGS. 5A and 5B are graphs illustrating exemplary histograms of channels of an input image.

FIG. 6 is a block diagram of another exemplary DSP of the apparatus for determining the similarity shown in FIG. 1.

FIGS. 7A and 7B are diagrams illustrating an exemplary method of creating a histogram of real-time input images.

FIG. 8 is a block diagram of yet another exemplary DSP of the apparatus for determining the similarity shown in FIG. 1.

FIGS. 9A and 9B are diagrams illustrating an exemplary method of establishing an object area.

FIG. 10 is a block diagram of a further exemplary DSP of the apparatus for determining the similarity shown in FIG. 1.

FIG. 11 is a flowchart illustrating an exemplary method of determining a similarity between images.

FIG. 12 is a flowchart illustrating an exemplary method of determining a similarity between images.

FIG. 13 is a flowchart illustrating an exemplary method of determining a similarity between images.

FIG. 14 is a flowchart illustrating an exemplary recovery mode when an object is not included in an object area in the method of determining the similarity shown in FIG. 13.

FIG. 15 is a flowchart illustrating another exemplary recovery mode explained with reference to FIG. 14.

### DETAILED DESCRIPTION

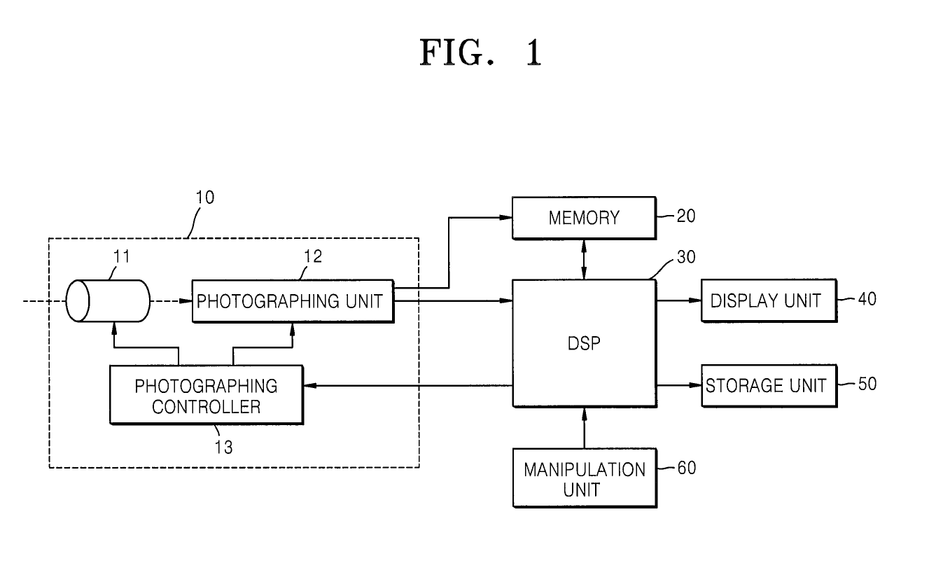

FIG. 1 is a block diagram of an exemplary apparatus for determining a similarity between images. The exemplary apparatus for determining the similarity described with reference to FIG. 1 includes a digital camera. However, the descriptions herein of embodiments including the digital camera should not be construed as limiting, as the exemplary apparatus may include any of a variety of digital devices for processing a digital image, such as a cellular phone, a camcorder, and the like.

Referring to FIG. 1, the digital camera may include an image input unit 10, a memory 20, a digital signal processor (DSP) 30, a display unit 40, a storage unit 50, and a manipulation unit 60. The image input unit 10 may receive an optical signal reflected from an object and provide an image signal in response to the optical signal. The memory 20 may temporarily store the image signal received from the image input unit 10. The DSP 30 may perform predetermined signal processing with regard to the image signal or generally control each element of the digital camera according to the image signal and/or an input control signal received from a user. The display unit 40 may display an image corresponding to the image signal. The storage unit 50 may store the image signal. The manipulation unit 60 may receive the input control signal from the user.

The image input unit 10 may include an optical unit 11 that inputs the optical signal reflected from the object, a photographing unit 12 that receives the optical signal transmitted from the optical unit 11 and forms an image of the object, and a photographing controller 13 that controls the optical unit 11 and the photographing unit 12.

The optical unit 11 may include lenses through which the optical signal (light) passes, an iris that controls the amount of light entering the image input unit 10, and a shutter that controls an input of the optical signal. The lenses may include a zoom lens that narrows or widens a viewing angle according to a focal length and a focus lens that focuses the object. The lenses may include a single zoom lens and a single focus lens, and may include a group of zoom lenses and focus lenses. The shutter may include a mechanical shutter that moves up and down, or an electronic shutter that controls supply of an electrical signal to an imaging device instead of a mechanical shutter. The optical unit 11 may further include a driving system for driving the lenses, the iris, and the shutter. The driving system may control locations of the lenses, opening of the iris, and operation of the shutter according to the control signal received from the photographing controller 13 in order to perform auto-focus, automatic exposure control, iris control, zooming, focus change, and the like.

The photographing unit 12 may include an imaging device that converts the optical signal received from the optical unit 11 into an electric signal. The imaging device may use a complementary metal oxide semiconductor (CMOS) sensor array, a charge coupled device (CCD) sensor array, and the like. The photographing unit 12 may further include an analog to digital converter (ADC) that digitizes the electrical signal that is an analog signal received from the CCD. The photographing unit 12 may further include a circuit that controls a gain or standardizes a waveform with regard to the electrical signal received from the imaging device.

The photographing controller 13 may include a timing generator as well as a controller that controls driving of the optical unit 11 and may control signal processing performed by the imaging device and the circuit according to a timing signal provided by the timing generator.

The photographing controller 13 may receive the image signal received from the image input unit 10, the user's input control signal received through the manipulation unit 60, and a control signal according to an algorithm stored in the storage unit 50 from the DSP 30, and may control the optical unit 11 and the photographing unit 12.

The memory 20 may temporarily store raw data (RGB data) of the image received from the image input unit 10. Predetermined image signal processing may be performed with regard to the raw data according to the calculation of the DSP 30 or the raw data may be transferred to another element. Also, the memory 20 may temporarily store executable data that is converted from algorithm data stored in the storage unit 50. The DSP 30 may perform calculations by using the data stored in the memory 20 and perform an operation according to the algorithm. The memory 20 may temporarily store image data that is decompressed and converted from an image file stored in the storage unit 50. The image data may be transmitted to the display unit 40. The display unit 40 may display a predetermined image. The memory 20 may include a volatile memory, RAM, etc. that temporarily stores data while power is supplied.

The DSP 30 may reduce noise of the image signal with regard to the input image signal, and perform image signal processing, such as gamma correction, color filter array interpolation, color matrix, color correction, and color enhancement with regard to the image signal. The DSP 30 may compress image data generated by performing image signal processing, generate an image file, or restore the image data from the image file. The image data may be reversibly or non-reversibly compressed. For example, the image data may be converted into Joint Photographic Experts Group (JPEG) format or JPEG 2000 format. The DSP 30 may functionally perform sharpening, color processing, blurring, edge emphasis processing, image analysis processing, image recognition processing, image effect processing, etc. The image effect processing may include generation of an enlarged or reduced image of a part of an imaging signal, an emphasis display of a part of a mosaic image, a luminance inversion image, a soft focus, and a change in a color atmosphere of a whole image, etc. The DSP 30 may perform display image processing for displaying the image on the display unit 40. For example, the DSP 30 may perform luminance level control, color correction, contrast control, outline emphasis control, screen division processing, generation of a character image, and image combination processing, etc.

The display unit 40 may display a predetermined image by realizing the image signal provided from the DSP 30. The display unit 40 may include a liquid crystal device, an organic light-emitting diode (OLED) display device, an electrophoretic display device, etc.

The storage unit 50 may compress the image file generated by compressing the image data in the DSP 30. The storage unit 50 may include a hard disc drive (HDD), a memory card embedded with a solid memory such as a flash memory, an optical disc, an optical magnetic disc, a hologram memory, etc.

The storage unit 50 may store an operating system (OS) necessary for operating the digital camera and data that executes an algorithm of the method of determining the similarity between images, of the present embodiment. The storage unit 50 may include a read-only memory (ROM) that is a non-volatile memory. The memory 20 may temporarily store executable data that is converted from the data stored in the storage unit 50. The DSP 30 may perform calculations according to the executable data stored in the memory 20.

The manipulation unit 60 may include a member used to manipulate the digital camera or perform various settings when a user captures an image. For example, the manipulation unit 60 may be realized as a button, a key, a touch screen, a dial, etc. and may be used to input the user's input control signal, such as power on/off, imaging start/stop, reproduction start/stop, driving of an optical system, manipulation of a menu, manipulation of selection, and the like.

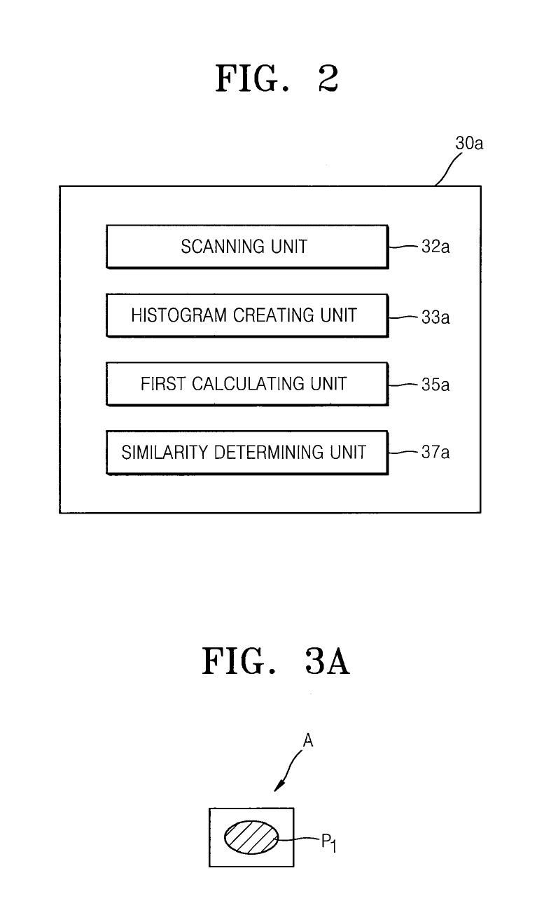

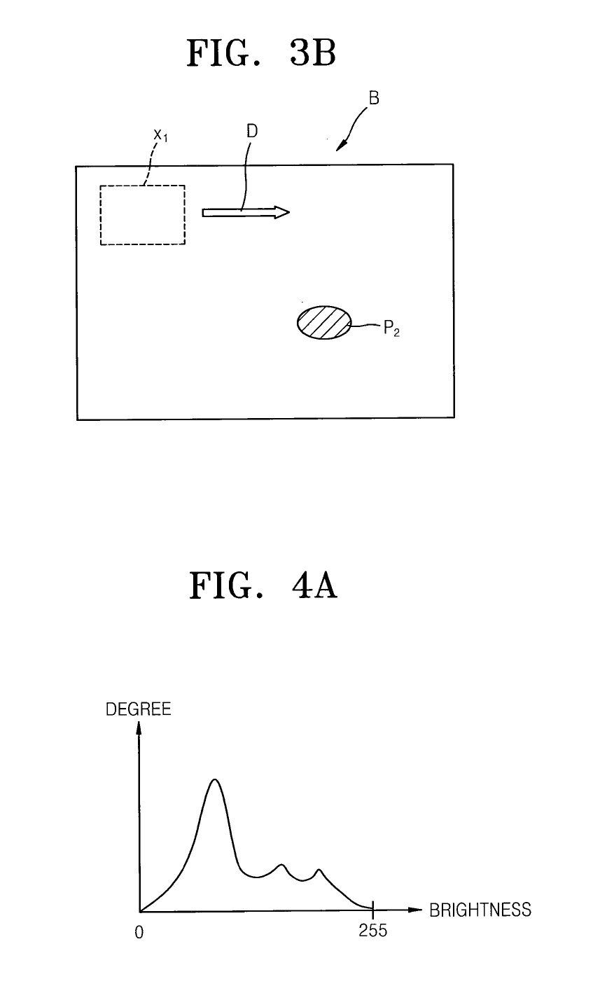

FIG. 2 is a block diagram of an exemplary digital signal processor (DSP) 30a of the apparatus for determining the similarity shown in FIG. 1. The DSP 30a will be described in more detail with reference to FIGS. 3A through 5B.

Referring to FIG. 2, the DSP 30a comprises a histogram creating unit 33a that may create a histogram of an input image, a first calculating unit 35a that calculates a difference in histogram degree between the input image and a template image, and a similarity determining unit 37a that determines that the smaller the difference is, the greater a similarity between the input image and the template image.

The DSP 30a may further comprise a scanning unit 32a that scans an image including a plurality of areas and specifies each area. In this regard, the histogram creating unit 33a may create a histogram of each area. The first calculating unit 35a may calculate a difference in histogram degree between one of the areas and the template image. The similarity determining unit 37a may determine that the smaller the difference is, the greater the similarity between the one of the areas of the image and the template image. The similarity determining unit 37a may select a smallest one from among differences in histogram degree between each of the areas and the template image, and determine that an image of one of the areas of the image having the smallest difference is most similar to the template image. Thus, an object that is to be desired may be disposed in one of the areas of the image having the smallest difference, so that the object can be tracked, and face recognition and scene recognition can be performed when in corresponding modes. For example, if a user selects an object from a previous image, and forms a template image including the object from the previous image, the similarity determining unit 37a may compare the template image with real-time input images and determine a similarity between the template image and the real-time input images, in order to track the object.

FIG. 3A illustrates an exemplary template image A. FIG. 3B illustrates an exemplary input image B. As an example, the template image A may be previously determined. The template image A may include a specific object P1. A user may form the template image A by using previous images. The image input unit 10 of the digital camera may input an image B shown in FIG. 3B, and determine a similarity between the image B and the template image A. The image B includes a specific object P2.

The similarity between the image B and the template image A may be determined by scanning the image B. The image B may be scanned in a determined direction D. If the image B is greater in size than the template image A, a similarity between the template image A and an area X1 of the image B having the same size as the template image A may be determined. The image B may be scanned in a predetermined period of time, an image of the area X1 may be specified and the similarity determined, an image of another area that is physically displaced from the area X1 may be specified, and the similarity may be continuously determined as the image B is scanned.

Histograms of RGB data may be used to determine the similarity between the template image A and the image B. A horizontal axis of a histogram of an 8 bit image represents gradation values between 0-255 and a vertical axis thereof represents a degree of each gradation value. In order to reduce calculations, the histograms of the RGB data may be created by establishing the vertical axis as a reduced set of values, such as values 0-63.

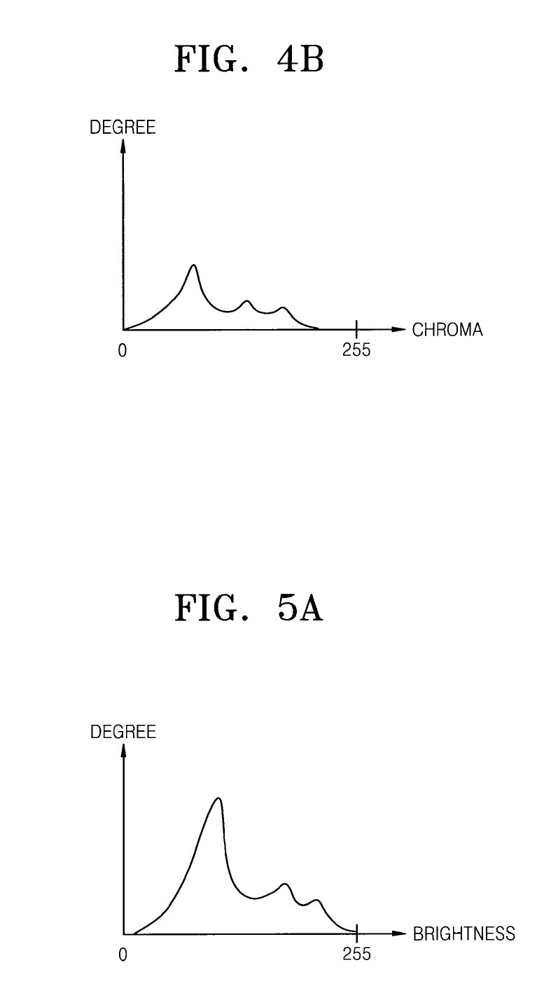

For example, FIGS. 4A and 4B are graphs illustrating exemplary histograms of channels of template image A. The channels may include RGB color model data of the template image A. The R or B data of the RGB color model may denote chroma, and the G data may denote brightness. Referring to FIG. 4A, the histograms may indicate gradation degrees of brightness. Referring to FIG. 4B, the histograms may indicate gradation degrees of chroma.

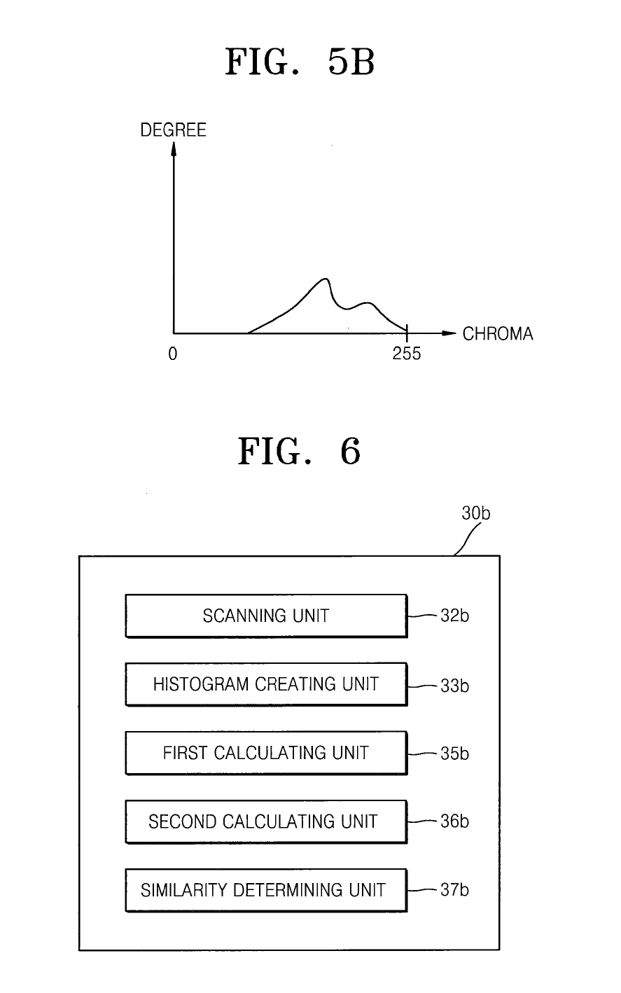

FIGS. 5A and 5B are graphs illustrating exemplary histograms of channels of input image B. Referring to FIG. 5A, the graph may illustrate a histogram indicating gradation degrees of brightness of the image of the area X1 of the image B. Referring to FIG. 5B, the graph may illustrate a histogram indicating gradation degrees of chroma of the image of the area X1 of the image B. Like the template image A, histograms of the image of the area X1 may be indicated by using the RGB data of the image B.

In an embodiment, RGB data that is initially input as image data representing an object at a distance may be used to indicate histograms, without needing to convert the image data into another color space, so that histograms may be more easily created. In other embodiments, histograms may be created by converting image data into another image data format or color model such as YCbCr, Lab, etc.

The created histograms may be used to create a difference in histogram degree between the template image A and the image of the area X1 for each created histogram. The difference may be indicated by a value obtained by summing each difference in histogram degree of each channel and gradation of each channel in all channels and gradations. In particular, in order to reduce a processing time, the difference may be a value obtained by subtracting the histogram degree of the image of the area X1 from that of the template image by using equation 1 below. In equation 1, S denotes a difference in the histogram degree, i denotes gradation, j denotes a channel, H(A) denotes a histogram degree of the template image A, and H(B) denotes a histogram degree of the image B.

$$S = {\sum }_{j = 1}^{3} {\sum }_{i = 0}^{255} {( H ( {A}_{ji} ) - H ( {B}_{ji} ) )}^{2} \qquad 1 )$$

A difference in the histogram degree between the template image A and each area of the image B may be created and an area of the image B having a smallest difference may be determined to be similar to the template image A. The areas of the image B may be scanned, differences in histogram degree between the template image A and the areas of the image B may be created, an area of the image B having a smallest difference value may be tracked, and the tracked area may be determined as an area having a high similarity between the template image A and the image B.

Therefore, a similarity between the template image A and the image B may be easily determined by using a difference in histogram degree. In particular, the similarity may be determined by using the RGB data that is the image data representing an object at a distance, in a reduced period of time.

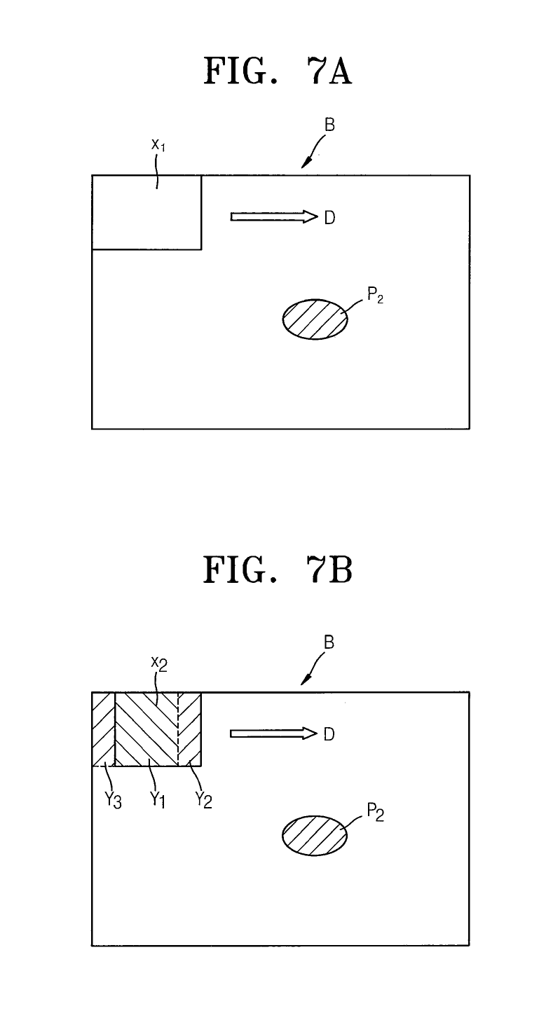

FIG. 6 is a block diagram of another exemplary DSP 30b of the apparatus for determining the similarity shown in FIG. 1. The DSP 30b will be described in more detail with reference to FIGS. 7A through 7B.

Referring to FIG. 6, the DSP 30b may comprise a scanning unit 32b that scans an input image and specifies a plurality of areas of the input image, a histogram creating unit 33b that creates a histogram of a first area of the areas, a first calculating unit 35b that calculates a difference in histogram degree between the first area of the input image and a template image, a second calculating unit 36b that calculates a difference in histogram degree between an image of a second area and the template image from a difference in histogram degree between the image of the first area and the template image, and a similarity determining unit 37b that determines that the smaller the difference is, the greater a similarity between the input image and the template image.

FIGS. 7A and 7B are diagrams illustrating an exemplary method of creating a histogram of real-time input images. As an example, determining of a similarity between input images B shown in FIGS. 7A and 7B and the template image A shown in FIG. 3A will be now described. Referring to FIG. 7A, the input image B may be bigger than the template image A, and a plurality of areas of the input image B having the same size as the template image A may be sequentially scanned. For example, the input image B may be scanned by moving pixels, which are in a row of the areas of the input image B having the same size as the template image A, to the right. The input image B may include a specific object P2. A histogram of an image of the first area X1 among the areas of the input image B may be created. As described with reference to FIG. 2, the histogram may be indicated by using the RGB data. The histogram of the image of the first area X1 may be temporarily stored.

Referring to FIG. 7B, an image of a second area X2 that moves from the image of the first area X1 may be specified, and a difference in the histogram degree between the template image A and the image of the second area X2 may be created. The difference in histogram degree between the template image A and the image of the second area X2 may be created from the difference in histogram degree between the template image A and the image of the first area X1. The difference in histogram degree between the template image A and the image of the second area X2 may be created by adding a difference in a second histogram degree between the template image A and an area Y2 of the first area X1 that is added to the second area X2 to a difference in a first histogram degree between the template image A and an area Y1 where the images of the first area X1 and the second area X2 overlap. A difference in histogram degree between the area Y1 and the template image A may be created by subtracting a difference in a third histogram degree between an area Y3 that is included in the first area X1 and is excluded from the second area X2 and the template image A from the first area X1.

For example, if the input image B is 640×480, and the template image A is 100×100, a difference in histogram degree between 640×480 (307200) of the input image B and the template image A may be created. However, by using the method above, the difference in histogram degree between the second area X2 that is scanned after the first area X1 is scanned and the template image A may be created by adding the difference in histogram degree of the area Y2 and the template image A to the difference in histogram degree between the first area X1 and the template image A and subtracting the difference in histogram degree between the area Y3 and the template image A from the difference in histogram degree between the first area X1 and the template image A, so that a calculation number is reduced to 7.4×2×480 (7104). Therefore, the time taken to create the difference in histogram degree between the image of the second area X2 and the template image A can be reduced by about 43 times.

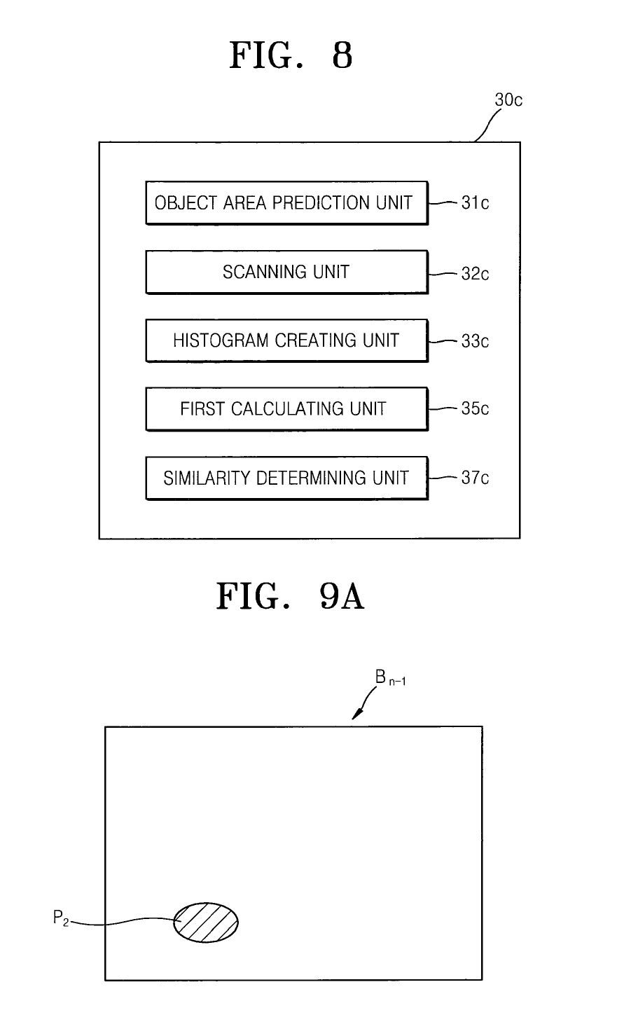

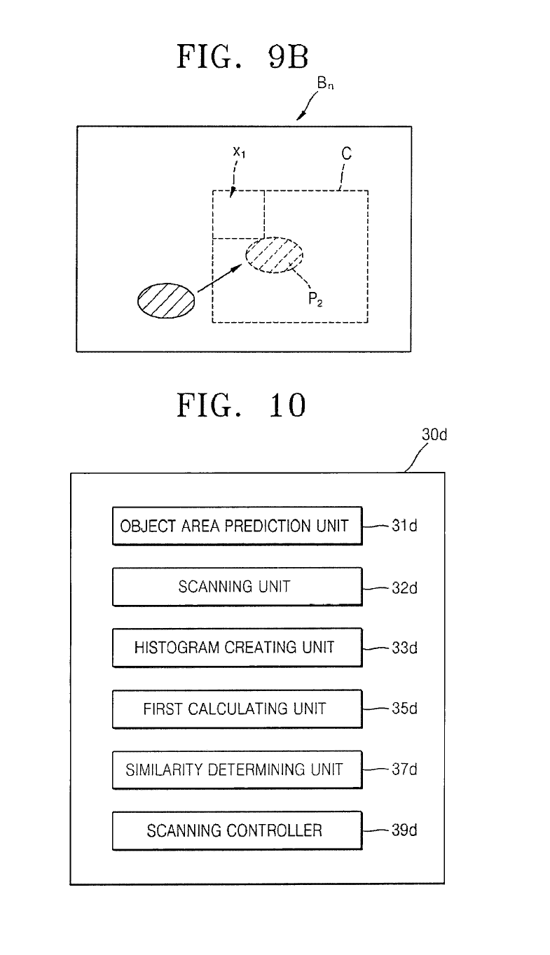

FIG. 8 is a block diagram of yet another exemplary DSP 30c of the apparatus for determining the similarity shown in FIG. 1. The DSP 30c will be described in more detail with reference to FIGS. 9A through 9B.

Referring to FIG. 8, the DSP 30c may comprise an object area prediction unit 31c that predicts an object area with regard to an input image, a scanning unit 32c that scans the object area, a histogram creating unit 33c that creates a histogram of the object area, a first calculating unit 35c that calculates a difference in histogram degree between the object area and a template image, and a similarity determining unit 37c that determines that the smaller the difference is, the greater a similarity between the object area and the template image.

FIGS. 9A and 9B are diagrams illustrating an exemplary method of establishing an object area. Referring to FIGS. 9A and 9B, an object area C where an object P2 of a current image Bn is located is predicted from previous images Bn−1. For example, a Kalman filter may be used to predict the object area C. A location of the object P2 may be determined from the previous images Bn−1, a speed for moving the object P2 may be calculated, and the object area C including an area where the object P2 is located may be predicted from the current image Bn by using an average, a standard deviation, and a variance of the speed. A similarity between an image of the object area C and the template image A may be determined. The template image A is shown in FIG. 3A.

A difference in histogram degree between the image of the object area C and the template image A may be created, and the similarity therebetween may be determined. If the object area C has the same size as the template image A, a histogram of the image of the object area C may be created, the difference in histogram degree between the image of the object area C and the template image A may be created, and the similarity therebetween may be determined. However, if the image of the object area C is greater than the template image A, the image of the object area C may be scanned, and histograms of images of a plurality of areas of the object area C may be created. Each area of the object area C may be equal in size to the template image A. Thereafter, a difference in histogram degree between each area of the object area C and the template image A may be created, and a determination may be made that the smaller the difference is, the greater the similarity therebetween. The determination of similarity described with reference to FIGS. 2 and 6 may be applied to the creation of the difference in histogram degree and determination of the similarity of the present embodiment. Although the similarity between the input image B and the template image A may be determined as described with reference to FIGS. 2 and 6, the similarity between the image of the object area C of the current image Bn and the template image A may be determined as described in the present embodiment.

FIG. 10 is a block diagram of a further exemplary DSP 30d of the apparatus for determining the similarity shown in FIG. 1. The DSP 30d may further comprise a scanning controller 39d in addition to embodiments of the elements of the DSP 30c shown in FIG. 8. The scanning controller 39d may determine whether a difference in histogram degree created from an image of the object area C is greater than a predetermined boundary value, and, if the difference is greater than the predetermined boundary value, may determine that the object area C does not include an object (e.g., P2). In more detail, although the object area C of the current image Bn may be scanned, if the difference in histogram degree of the object area C is not created to the extent that the object area C includes the object, the scanning controller 39d may determine that the object is not included in the object area C. If an input image is 640×480, it may take about 30 ms to scan the object area C. It may take about 20 ms to scan an object area smaller than the input image. For example, when a CPU of 166 Mhz is installed in the digital camera, it may take approximately 33.33 ms in real-time to scan the object area C, which may preclude determining a similarity between a real-time input image and the template image A if an object from the object area C of the current image Bn fails to be located and the object is located by scanning the whole image again. Therefore, if the object is not located from the object area C of the current image Bn, i.e. if an area having a reference similarity with the template image A is not located, a next image may be input, the scanning controller 39d may control scanning of the next image, creation of a histogram, and creation of a difference in histogram degree between the next image and the template image.

Alternatively, the scanning controller 39d may control a determination that the object area C does not include the object if the difference in histogram degree between the object area C and the template image A is greater than a minimum range of differences in histogram degree between the previous images Bn−1 and the template image A, and determine the similarity between the next image and the template image A. For example, if a difference in histogram degree between the template area A and each area including the object of the previous images Bn−1 is 1000, and a minimum difference in histogram degree between the template area A and the object area C of the current image Bn is 10000, the scanning controller 39d may determine that the object area C does not include the object. That is, if a minimum difference in histogram degree between the template image B and the object area C where the object is predicted to be included in the current image Bn is remarkably different from that between the previous images Bn−1 and the template image A due to erroneously predicting the object area C or determining that the object disappears, the scanning controller 39d may determine that the object area C does not include the object. As described above, the scanning controller 39d may input the next image, completely scan the next image, and determine a similarity between the next image and the template image A, in order to track a location of the object with regard to a real-time input image.

The scanning controller 39d may be used to perform a recovery mode and precisely and efficiently track the object.

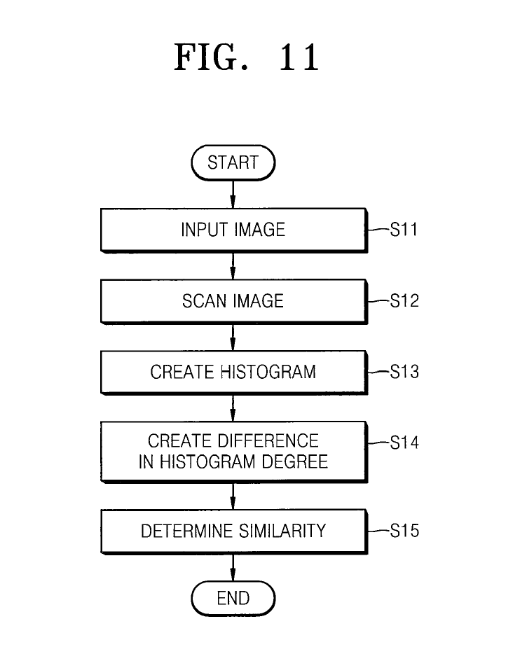

FIG. 11 is a flowchart illustrating an exemplary method of determining a similarity between images. Referring to FIG. 11, an image may be input (operation S11). If a size of the image is greater than a previously stored template image, a plurality of areas of the image having the same size as the template image may be scanned and tracked (operation S12). A histogram of each area of the image may be created (operation S13). A difference in histogram degree may be created for each histogram (operation S14). A value obtained by summing all differences in histogram degree between the areas and the template image in all gradations and all channels may be calculated. In determining similarity, a smallest difference value in histogram degree between the areas of the image and the template image may be determined. That is, an area of the image having the smallest difference value may be tracked, and the area may be determined to be most similar to the template image (operation S15).

If the image has the same size as the template image, a histogram of the entire image may be created, a difference in histogram degree between the template image and the image of each channel may be created, and a similarity obtained by summing the differences in all channels may be determined. It may be determined whether an object of the template image is included in the image by comparing the similarity with a boundary value.

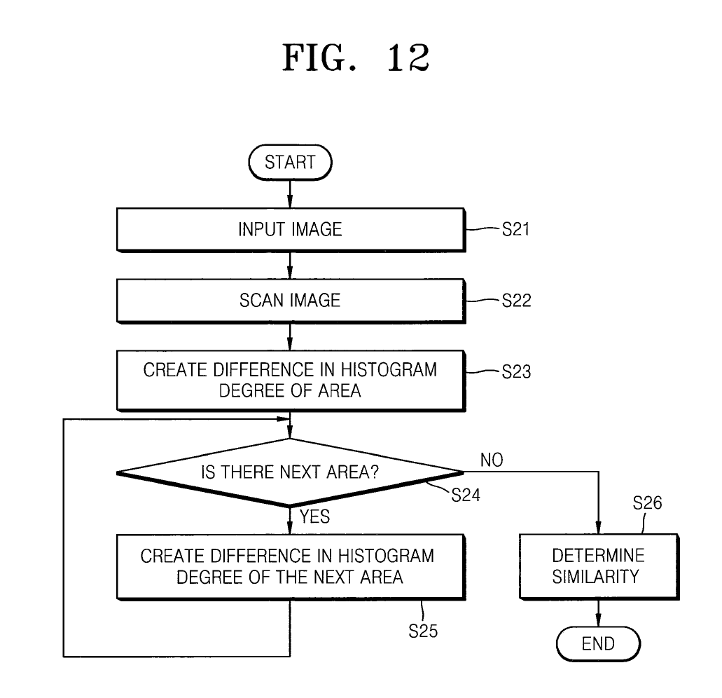

FIG. 12 is a flowchart illustrating an exemplary method of determining a similarity between images. The method of determining the similarity may be performed at a reduced period time by reducing the amount of calculation. The method may correspond to the method shown in FIGS. 7A and 7B.

Referring to FIG. 12, an image may be input (operation S21). The image may be scanned (operation S22). If the input image is greater in size than a template image, a plurality of areas of the input image having the same size as the template image may be specified and tracked. A histogram of an area of the input image may be created, and a difference in histogram degree between the area and the template image may be created (operation S23). Creation of the difference in histogram degree between an image of the area and the template image is described herein with reference to other embodiments, and thus a detailed description thereof will not be repeated here.

It may be determined whether a next area is included in the input image (operation S24). If it is determined that the next area is included in the input image, a difference in histogram degree between an image of the next area and the template image may be created (operation S25). For example, the next area may be specified by moving a row of pixels to the right of the area. A difference in histogram degree between an image of the next area and the template image may be created by adding a difference in a second histogram degree between a row of pixels and the template image added from the difference in histogram degree between the image of the area and the template image to a difference in a first histogram degree between the template image and an area where the area and the next area overlap. The difference in the first histogram degree may be created by deleting a difference in a third histogram degree between a row of pixels that is excluded from the area and the template image from the difference in the histogram degree between the image of the area and the template image. Again, a determination may be made whether another next area is included in the input image (operation S24). If the determination is made that another next area is not included in the input image, one of the areas having a smallest difference value may be determined to be most similar to the template image, i.e. to have a high similarity (operation S26).

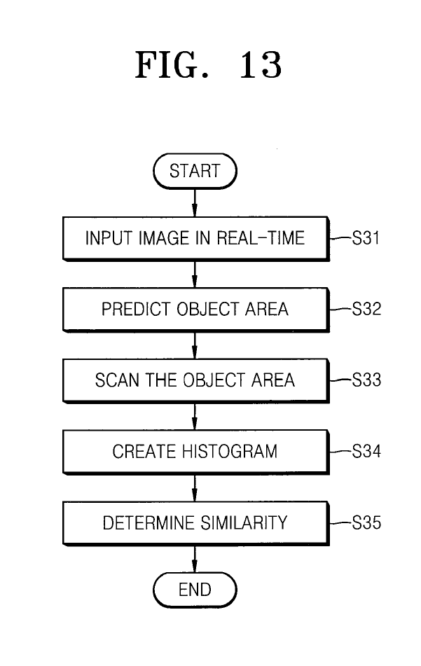

FIG. 13 is a flowchart illustrating an exemplary method of determining a similarity between images. The method may correspond to the method shown in FIGS. 9A and 9B.

Referring to FIG. 13, an image may be input in real-time (operation S31). An object area may be predicted from previous images (operation S32). For example, previous images of 10 frames may be input, a motion distance of an object between frames may be modeled by using a Kalman filter, and an object area including an area where an object is located may be predicted from a current image of an 11^{th} frame. If the image size is 640×480, the object area may be 160×160 in size. The object area may be scanned (operation S33), and a histogram may be created (operation S34). A difference in histogram degree between an image of the object area and a template image may be created and a similarity therebetween may be determined (operation S35). Creation of the histogram, the difference in the histogram degree, and determining of the similarity may be performed in a same manner as described with reference to FIG. 11 or FIG. 12. Compared to the determination of the similarity between an entire image and the template image, the similarity between the object area and the template image may be determined in a reduced period of time.

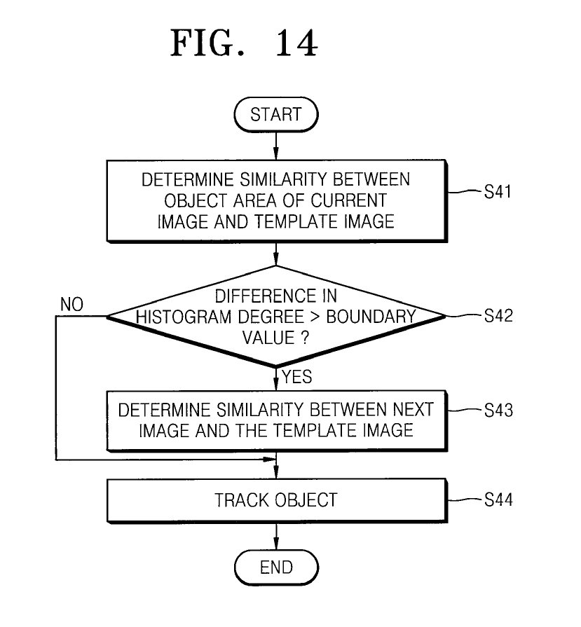

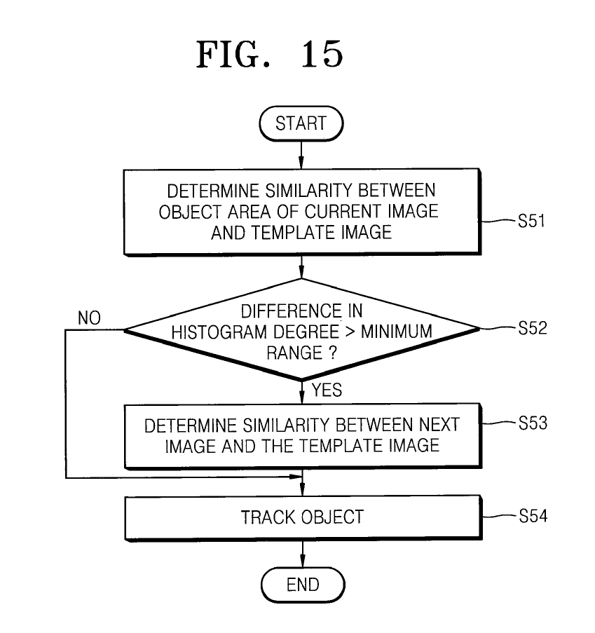

FIGS. 14 and 15 are flowcharts illustrating exemplary methods of determining a similarity between images, which further comprise performing a recovery mode when an object is not included in an object area. In particular, FIG. 14 is a flowchart illustrating an exemplary recovery mode when an object is not included in an object area in the method of determining the similarity shown in FIG. 13. FIG. 15 is a flowchart illustrating another exemplary recovery mode explained with reference to FIG. 14.

Referring to FIG. 14, a similarity between an object area of a current image and a template image may be determined by using a difference in histogram degree (operation S41). A determination may be made whether the difference in histogram degree is greater than a previously determined boundary value based on an experience rule (operation S42). If the difference in histogram degree is determined to be greater than the previously determined boundary value, a similarity between a next image and the template image may be determined (operation S43). If tracking an object in the object area of the current image in view of a real-time operation fails, the object may be tracked by determining the similarity between the next image and the template image based on a scanning time (operation S44). Alternatively, if the difference in histogram degree is not greater than the previously determined boundary value, an area including the object in the object area of the current image may be tracked (operation S44).

Referring to FIG. 15, a similarity between an object area of a current image and a template image may be determined (operation S51). A determination may be made whether a difference in histogram degree between the object area and the template image is greater than a minimum range (operation S52). The minimum range may include differences in histogram degree between an area including an object of previous images and the template image, i.e. a range of a smallest difference in the histogram degree. If a determination is made that the difference in the histogram degree is greater than the minimum range, a similarity between a next image and the template image may be determined (operation S53). An object may be tracked by locating an area of the next image having the smallest difference in histogram degree (operation S54). Alternatively, if a determination is made that the difference in the histogram degree is not greater than the minimum range, the object of the object area of the current image may be tracked (operation S54).

In various embodiments, a similarity between an input image and a previously stored template image may be determined, thereby effectively locating an object of the template image from the input image. Therefore, a digital image processing apparatus may effectively perform face recognition, scene recognition, object tracking, and the like, by using a similarity determining method.

Embodiments described herein may also be embodied as computer readable code executable by a processor and stored on a computer readable storage medium. The computer readable storage medium may include the storage unit 50, as illustrated in FIG. 1. The computer readable storage medium may include any data storage device that can store data which can thereafter be read by a computer system. Examples of the computer readable storage medium include integrated circuits, read-only memory (ROM), random-access memory (RAM), flash memory, magnetic tapes, hard disks, floppy disks, optical data storage devices, CD-ROM's, DVD's, and carrier waves (such as data transmission through the Internet). A program stored in a storage medium may be expressed in a series of instructions used directly or indirectly within a device with a data processing capability, such as, a computer. Thus, a term “computer” involves all devices with data processing capability in which a particular function is performed according to a program using a memory, input/output devices, and arithmetic logics.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. It will be recognized that the terms “comprising,” “including,” and “having,” as used herein, are specifically intended to be read as open-ended terms of art.

What is claimed is:

1. A method for determining similarity between images, the method comprising:
inputting an image;
creating a difference in histogram degree between the image and a template image; and
determining that the smaller the difference is, the greater the similarity.

2. The method of claim 1, further comprising:
scanning the image; and
creating a difference in histogram degree between an area of the scanned image and the template image.

3. The method of claim 2, further comprising:
creating a difference in histogram degree between a first area of the scanned image and the template image; and
creating a difference in histogram degree between a second area of the scanned image and the template image.

4. The method of claim 3, wherein the creating of the difference in histogram degree between the second area of the scanned image and the template image comprises:
creating a difference in a first histogram degree between an area where the first area and the second area overlap and the template image;
creating a difference in a second histogram degree between an area of the first area that is added to the second area and the template image; and
creating the difference in the histogram degree between the second area and the template image by adding the difference in the first histogram degree to the difference in the second histogram degree.

5. The method of claim 4, wherein the creating of the difference in the first histogram degree between the area where the first area and the second area overlap and the template image comprises: excluding a difference in the histogram degree between the template image and an area where the first area and the second area do not overlap from the difference in the histogram degree between the first area and the template image.

6. The method of claim 3, wherein the creating of the difference in histogram degree between the second area of the scanned image and the template image comprises:
creating a difference in a second histogram degree between an area of the second area that is added to the first area and the template image;
creating a difference in a third histogram degree between an area of the first area that is excluded from the second area and the template image;
adding the difference in the second histogram degree to the difference in histogram degree between the first area and the template image; and
subtracting the difference in the third histogram degree.

7. The method of claim 2, wherein the area of the scanned image has a same size as the template image.

8. The method of claim 1, wherein a plurality of difference in histogram degrees are created, each of the plurality of difference in histogram degrees created using a different channel.

9. The method of claim 8, further comprising:
creating a difference in a gradation degree of each channel;
calculating a sum of the differences in all channels and all gradations; and
determining that the smaller the sum is, the greater the similarity.

10. The method of claim 1, wherein the difference in histogram degree is created in terms of chroma and brightness.

11. The method of claim 1, further comprising:
inputting a plurality of previous images;
predicting a location of an object of a current image from the plurality of previous images;
inputting the current image; and
creating a difference in histogram degree between the template image and an image of an object area including the location of the object of the current image.

12. The method of claim 11, wherein the predicting of the location of the object of the current image from the plurality of previous images comprises using an average and a variance of a speed of motion of the object.

13. The method of claim 11, further comprising:
scanning the object area; and
creating a difference in histogram degree between an area of the scanned object area and the template image.

14. The method of claim 11, wherein a plurality of difference in histogram degrees are created, each of the plurality of difference in histogram degrees created using a different channel.

15. The method of claim 14, further comprising:
creating a difference in a gradation degree of each channel;
calculating a sum of the differences in all channels and all gradations; and
determining that the smaller the sum is, the greater the similarity.

16. The method of claim 11, further comprising:
creating a difference in histogram degree between the template image and a plurality of areas of the object area;
determining that the object area does not include the object if a smallest difference value is greater than a boundary value;
inputting a next image; and
creating a difference in histogram degree between the template image and a plurality of images of the next image.

17. The method of claim 11, further comprising:
creating a difference in histogram degree between the template image and a plurality of areas of the object area;
comparing a minimum range of differences in histogram degree between the previous images and the template image and a smallest difference value between the template image and the object area;
inputting a next image; and
creating a difference in histogram degree between the template image and a plurality of images of the next image.

18. A computer readable storage medium having stored thereon a program executable by a processor to perform a method comprising:
inputting an image;
creating a difference in histogram degree between the image and a template image; and
determining that the smaller the difference is, the greater the similarity.

19. A similarity determining apparatus, comprising:
a histogram creating unit configured for creating a histogram of an input image;
a first calculating unit configured for creating a difference in histogram degree between the input image and a template image; and
a similarity determining unit configured for determining that the smaller the difference is, the greater the similarity.

20. The apparatus of claim 19, wherein the first calculating unit is further configured for creating a plurality of difference in histogram degrees, each of the plurality of difference in histogram degrees created using a different channel.

21. The apparatus of claim 19, wherein the first calculating unit is further configured for calculating a sum of differences in histogram degree between the input image and the template image in all channels and all gradations.

22. The apparatus of claim 19, further comprising a scanning unit configured for scanning the input image and specifying a plurality of areas of the input image,
wherein the histogram creating unit is further configured for creating a histogram of each area of the input image specified by the scanning unit, and
wherein the first calculating unit is further configured for creating a difference in histogram degree between each area of the input image and the template image.

23. The apparatus of claim 22, wherein the scanning unit is further configured for sequentially specifying first and second areas of the input image,
the histogram creating unit is further configured for creating a histogram of the first area of the input image;
the first calculating unit is further configured for creating a difference in histogram degree between the first area of the input image and the template image; and
the apparatus further comprising a second calculating unit configured for creating a difference in histogram degree between the second area of the input image and the template image by adding a difference in a first histogram degree between an area where the first area and the second area overlap and the template image to a difference in a second histogram degree between an area of the first area that is added to the second area and the template image.

24. The apparatus of claim 23, wherein the second calculating unit is further configured for subtracting a difference in histogram degree between the template image and an area where the first area and the second area do not overlap from the difference in histogram degree between the template image and the first area.

25. The apparatus of claim 22, wherein the scanning unit is further configured for sequentially specifying first and second areas of the input image,
the histogram creating unit is further configured for creating a histogram of the first area of the input image;
the first calculating unit is further configured for creating a difference in histogram degree between the first area of the input image and the template image; and
the apparatus further comprising a second calculating unit configured for creating a difference in histogram degree between the second area of the input image and the template image by creating a difference in a second histogram degree between an area of the second area that is added to the first area and the template image, creating a difference in a third histogram degree between an area of the first area that is excluded from the second area and the template image, adding the difference in the second histogram degree to the difference in histogram degree between the first area and the template image, and subtracting the difference in the third histogram degree.

26. The apparatus of claim 19, further comprising an object area predicting unit configured for predicting an object area including a location of an object of a current image from a plurality of previous images.

27. The apparatus of claim 26, further comprising a scanning controller configured for scanning the object area and specifying a plurality of areas of the object area; and
the histogram creating unit is further configured for creating a histogram of at least one area of the object area specified by the scanning unit.

28. The apparatus of claim 26, wherein
the histogram creating unit is further configured for creating a histogram of the object area; and
the first calculating unit is further configured for creating a difference in histogram degree between the object area and the template image.

29. The apparatus of claim 28, further comprising a scanning controller configured for determining whether the difference in histogram degree between the object area of the current image and the template image is greater than a boundary value, and if the difference is greater than the boundary value, controlling to scan a next image.

30. The apparatus of claim 26, further comprising a scanning controller configured for determining whether the difference in histogram degree between the object area of the current image and the template image is greater than a minimum range of previous images, and if the difference is greater than the minimum range, controlling to scan a next image.
